(19) United States
(12) Patent Application Publication
(10) Pub. No.: US 2002/0181824 A1
(43) Pub. Date: Dec. 5, 2002

(54) Compact polarization beam combiner/splitter

(76) Inventors: Shangyuan Huang, Kent, WA (US); Pai-Sheng Shen, Kent, WA (US)

Correspondence Address: Lee Hsu, Esq, BROBECK, PHLEGER & HARRISON LLP, 12390 El Camino Real, San Diego, CA, 92130-2081, US

(21) Appl. No.: 09/870,533

(22) Filed: May 30, 2001

(51) Int. Cl. G02B 6/27

(52) U.S. Cl. 385/11; 385/31

(57) ABSTRACT

An apparatus and method for splitting and combining optical beams. The apparatus comprises a pair of closely-spaced optical fibers that propagate optical beams through a first lens element that collimates both beams. An adjoining, a polarizing beam splitter element, typically in the form of a birefringent crystal or birefringent crystal assembly, then combines the optical beams. The combined optical beam then propagates through a second lens element which focuses the optical beam into an adjoining single optical fiber. The apparatus is configured to be compact and linear. By using a less-than quarter pitch first lens disposed adjacent a polarizing beam splitter element, focusing of the preferred embodiment of the present invention is less critical than with other combiner configurations.

### BACKGROUND OF THE INVENTION

1. Field of the Invention

The present invention relates in general to the field of optical fiber communications, and specifically relates to a bidirectional apparatus and a method for combining and splitting beams of polarized light using two GRIN lens elements, and a polarizing beam splitter element which typically is a pair of crystal wedges.

2. Description of Prior Art

Optical fiber communications requires combining and splitting light beams for various purposes. One purpose is to increase the optical power pumped into a fiber by combining the outputs of two pump lasers. Generally, to obtain high power from an optical amplifier, it is necessary to input a large amount of optical pump power. A straightforward solution to increase the pump power is to increase the driving current to the pump laser. However this can push the laser optical output only to a certain level. When the driving current is further increased, the laser output will be saturated. Moreover, the laser lifetime will be decreased if it is driven under this condition for a long time.

Therefore a ‘pump combiner’ becomes a very attractive approach that combines optical outputs of two pump lasers together into one beam. To one with knowledge in the field, it is known that there exists no passive reciprocal device that can fully combine two light beams with the same wavelength, unless they are orthogonal, and therefore independent, to each other.

Fortunately, the output beam of a laser diode is linearly polarized. This makes it possible to combine two orthogonal polarized laser beams together without interference. A polarization beam combiner allows using two low-power and low-cost pumps instead of one high-power and high-cost pump, achieving much better cost performance.

There have been various designs for polarization beam combiner/splitters. U.S. Pat. 5,740,288 to Pan provides a polarization beam splitter cube to combine or separate beams, as does U.S. Pat. No. 6,018,418 to Pan. In these structures, the multiple input/output ports face different directions and every single port consists of a fiber optic collimator. This dooms the device to a large size. In addition, the inconvenient angles in U.S. Pat. No. 6,018,418 add more difficulties to the device assembly process.

U.S. Pat. No. 6,026,203 to Chang and U.S. Pat. No. 6,014,256 to Cheng offer improved designs based on walk-off birefringent crystals (made of Calcite, YVO.sub.4, or TiO.sub.2, for example). The walk-off structure allows a one-direction device. In other words, all ports are located along one line so as to allow a slim shape of the device. An additional advantage of this one-direction nature is that only two surfaces (front and rear) of the beam combining element (in this case, the walk-off crystal) need to be AR-coated, unlike the former inventions that need multiple surfaces to be AR-coated.

Another very important advantage of the aforementioned walk-off based designs is that the two input beams are combined before collimation. It is known to anyone expert in the field that the transverse walk-off of the e-beam in a walk-off crystal is determined by the crystal length. The best ratio of walk-off to the crystal length is about 1 to 10. Therefore, if we want to combine the e-beam to the o-beam with an initial transverse spacing of d upon entering the crystal, a preferred crystal length is about 10d. In traditional walk-off configurations, the walk-off is disposed after the beam collimation and thus the crystal length has to be long, for example, in the range of 10 mm to 20 mm. This is because the diameter of a GRIN lens (the collimating element) is generally 1 mm to 2 mm, and therefore the two fiber centers have to be spaced by at least the diameter of the GRIN lens. However, in the inventions shown in U.S. Pat. No. 6,026,203 and U.S. Pat. No. 6,014,256, the two optical beams are combined immediately after the fiber tip. If the two fibers are disposed next to each other, for example, inserted into a glass capillary with 0.25 mm inner diameter, their center spacing becomes as small as 0.125 mm, which indicates that only a 1.25 mm-long walk-off crystal is needed. This makes the combiner/splitter a truly miniature device which uses less of an expensive crystal material.

Furthermore, U.S. Pat. No. 6,014,256 shows a much simpler design than U.S. Pat. 6,026,203, offering an easier assembly process.

The beam combining quality in the walk-off type combiners depends totally on the walk-off crystal. If the crystal is too short, the two beams will not meet completely. On the other hand, if it is too long, the two beams will cross each other before exiting the crystal. Neither case provides a low device loss. Therefore the design of the walk-off crystal in U.S. Pat. No. 6,014,256 is extremely critical. The design of the walk-off length is critical to determine whether the two beams miss or meet each other. Another disadvantage of the walk-off is that, for the purposes of balancing the optical paths of the two beams, a symmetrical configuration and a two-step walk-off process are necessary.

An alternative to the walk-off is a wedge or wedge assembly such as a Wollaston prism or a Rochon prism. Such a device could be designed so as to split or combine light in a one-step process, so as to provide easier assembly, a small footprint, and reduced expense.

U.S. Pat. No. 5,408,354 to Hosokawa teaches the use of a birefringent element in the form of a Wollaston or Rochon prism for separating an incident light beam into two light beams that are orthagonal to each other in polarization orientation and are not parallel to each other in the propagation direction, pursuant to the purposes of an optical isolator. Said invention does not address the particulars of directing the two light beams into separate optical fibers.

U.S. Pat. No. 5,930,039 to Li et al. teaches the use of two tapered birefringent plates for altering the angle of two light beams in an optical circulator. The invention uses a pair of walk-off elements for splitting and combining two polarized light beams.

U.S. Pat. No. 6,052,228 to Xie et al. shows the use of a Wollaston prism (modified) and a Rochon prism (modified) as a splitter or combiner. However, the invention uses the properties of the prism as a beam angle turner only.

It is a primary purpose of the present invention to provide a miniature combiner/splitter device that is easily assembled and inexpensive. It is another purpose of the present invention to utilize a wedge or wedge assembly to simplify assembly, minimize device footprint, and reduce cost of a combiner/splitter device.

### BRIEF SUMMARY OF THE INVENTION

A bi-directional, compact polarization beam combiner/splitter is described comprising a first lens element, a polarizing beam splitter element typically in the form of a wedge assembly, and a second lens element. The wedge assembly, for example a thin Wollaston prism, is provided to combine two collimated light beams of orthogonal polarization, said light beams having been collimated by the first lens element. The combined light beams are then focused on an optical fiber by a second lens element. The beam combiner/splitter functions as a combiner when two light beams are directed into the first lens element end of the apparatus, and functions as a splitter when a light beam is directed into the second lens element.

There has thus been outlined, rather broadly, the more important features of the invention in order that the detailed description thereof that follows may be better understood, and in order that the present contribution to the art may be better appreciated. There are, of course, additional features of the invention that will be described hereafter and which will form the subject matter of claims.

### BRIEF DESCRIPTION OF THE DRAWINGS

These and other features, aspects, and advantages of the present invention will become better understood with regard to the following description, appended claims, and accompanying drawings where:

FIG. 1 is a schematic of a front stage of a beam combiner in the prior art.

FIG. 2 is a schematic of a beam combiner/splitter based on a pair of birefringent crystal wedges.

FIGS. 3A and 3B are schematics of a polarization beam splitting element using a Wollaston prism, in the splitter and combiner configurations respectfully.

FIG. 4 is a schematic of a Wollaston prism model for calculation.

FIG. 5 is a graph of beam angle versus incidence angle (Ψ vs. φ1).

FIG. 6 is a graph of fiber spacing versus incidence angle (D vs. φ1).

FIG. 7 is a graph of beam angle versus angle of two oblique surfaces (Ψ vs. α).

FIG. 8 is a graph of fiber spacing versus angle of two oblique surfaces (D vs. α).

### DETAILED DESCRIPTION OF THE INVENTION

Before explaining at least one embodiment of the invention in detail, it is to be understood that the invention is not limited in its application to the details of construction, to the arrangements of the components set forth in the following description or illustrated in the drawings, and the detailed description of the invention. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

As used herein, a polarizing beam splitter element means any optical apparatus capable of splitting optical beams into linear components, or combining two linear components into a single beam. In this application, the polarizing beam splitter element is typically discussed with the two optical beams propagating through the polarizing beam splitter element in the direction that results in the beams being combined. However, an optical beam can be propagated though the polarizing beam splitter element in the opposite direction, which results in the optical beam being split into two linear components.

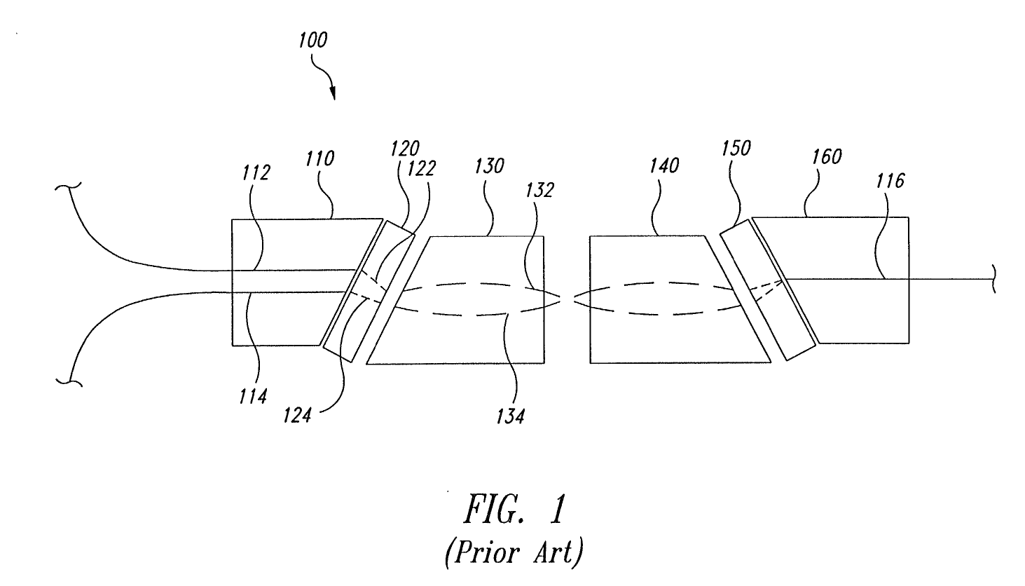

The prior art is shown in FIG. 1, which is a front stage 100 of a beam combiner. The front stage 100 comprises a dual fiber capillary 110 disposed adjacent a walk-off crystal 120. The walk-off crystal 120 is disposed adjacent a collimating element, depicted here as a GRIN lens 130. The dual fiber capillary 110 comprises a first fiber tip 112 and a second fiber tip 114, both tips 112 and 114 being bonded to the dual fiber capillary 110 by some means. The walk-off crystal 120 is here shown with a first uncollimated light beam centerline 122 and a second uncollimated light beam centerline 124. The collimated beams 132 and 134 are focused by GRIN lens 140. The second walk-off crystal 150 finally completes the combining and the output fiber tip 116 is disposed right at the focusing point of the combined beam. Reversing the input and output will make this device a splitter.

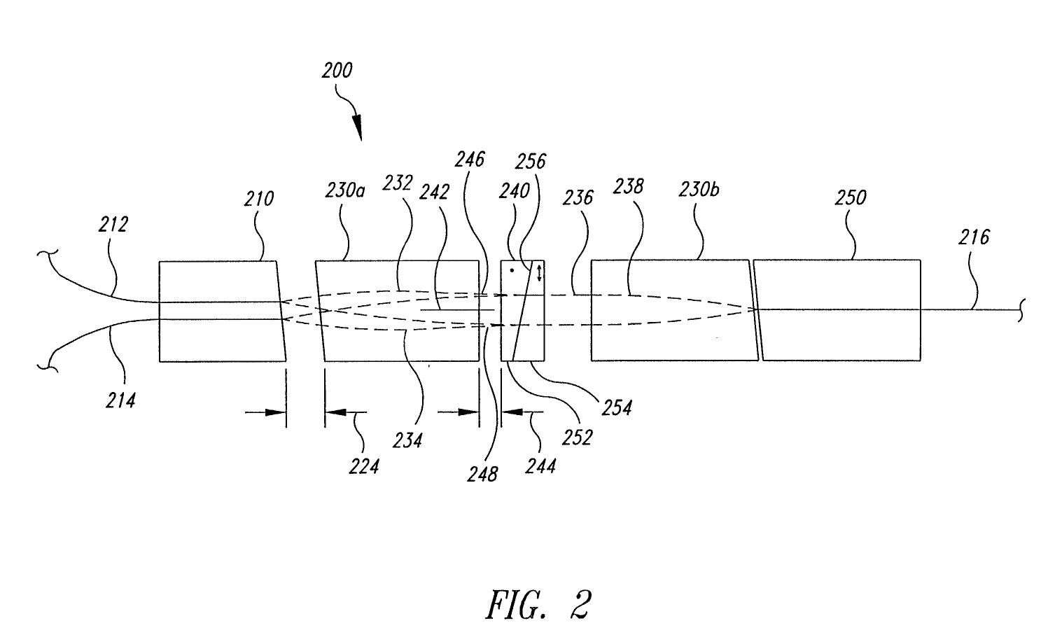

In FIG. 2, we show a preferred embodiment of the present invention. The preferred embodiment of the bidirectional beam combiner/splitter 200 comprises a dual fiber capillary 210, a first GRIN lens 230a, a polarizing beam splitter element in the preferred form of a pair of birefringent crystal wedges 240, a second GRIN lens 230b, and a single fiber capillary 250. The dual fiber capillary 210 comprises a first fiber tip 212 and a second fiber tip 214. The single fiber capillary 250 comprises a third fiber tip 216. The pair of birefringent crystal wedges 240 comprises a first crystal wedge 252, a second crystal wedge 254, and an interface 256.

The first GRIN lens 230a is less than a quarter pitch in length, which length allows a first offset beam 232 and a second offset beam 234 to be separately collimated as a first collimated beam 246 and a second collimated beam 248, converging upon exiting GRIN lens 230a, thence to meet within the polarizing beam splitter element. In the preferred embodiment, the polarizing beam splitter element is a pair of birefringent crystal wedges 240. The first collimated beam 246 and a second collimated beam 248 meet within the pair of birefringent crystal wedges 240 at the interface 256, so as to create a combined collimated beam 236. For the proper alignment of the first offset beam 232 and the second offset beam 234, the pair of birefringent crystal wedges 240 may be disposed a distance 244 from the first GRIN lens 230a. The combined collimated beam 236 enters the second GRIN lens 230b, which creates a converging light beam 238. The converging light beam 238 is then focused on the third fiber tip 216.

This very simple and compact structure is based on the pair of birefringent crystal wedges 240. Both fiber tips 212 and 214 share the same GRIN lens 230a for collimation, ensuring the slimness of the device. Because the two fiber tips 212 and 214 are transversely offset from a GRIN lens axis 242, each of the collimated beams 246 and 248 will be tilted with respect to said GRIN lens axis 242. A typical beam tilt angle, not shown, is approximately 1.8 degrees, based on the typical offset of each fiber core as 0.0625 mm (=0.125 mm/2) as well as some typical quarter pitch GRIN lens parameters.

The pair of birefringent crystal wedges 240 may form a Wollaston prism or a Rochon prism. In spite of many designs different in details (Wollaston prism or modified Wollaston prisms; Rochon prism or modified Rochon prisms), their common performance is to change the propagation directions of o-beams and e-beams, or change the direction of one beam only. In this patent, we will focus on the Wollaston prism although the principle will suit any similar prisms.

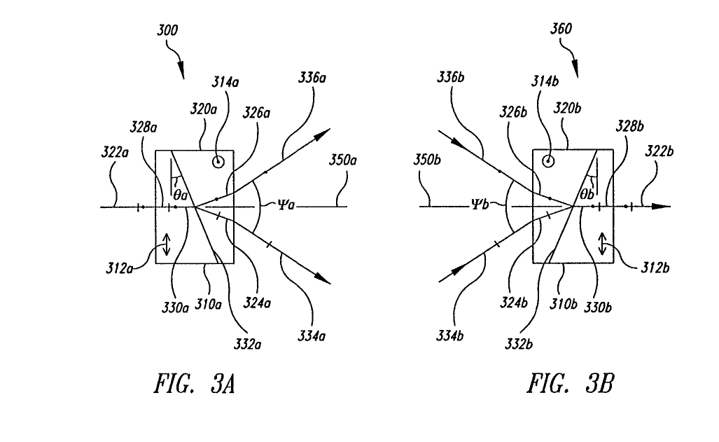

A traditional Wollaston prism functioning as a splitter 300 is shown in FIG. 3A, and a traditional Wollaston prism functioning as a combiner 360 is shown in FIG. 3B. Both the splitter 300 and the combiner 360 comprise a first wedge 310a and 310b, a second wedge 320a and 320b, and an interface 332a and 332b. The first wedges 310a and 310b include a first wedge optic axis 312a and 312b, respectively, and the second wedges 320a and 320b include a second wedge optic axis 314a and 314b, respectively.

Referring to FIG. 3A depicting the Wollaston prism functioning as a combiner, light beam 322a launched into the first wedge 310a will propagate straight for both a first o-beam 330a and a first e-beam 328a because the light beam 322a is normally incident to the interface 332a. The first o-beam 330a is that portion of the light beam 322a which is polarized perpendicular to the optic axis 312a, while the first e-beam 328a is that portion which is polarized in parallel to the optic axis 312a. Once the two beams 330a and 328a hit the interface 332a and enter the second wedge 320a, the original o-beam 330a becomes an e-beam 326a and the original e-beam 328a becomes an o-beam 324a, because the second wedge optic axis 314a is oriented at 90° with respect the first wedge optic axis 312a. A first polarized light beam 326a and a second polarized light beam 324a exit the splitter 300 becoming beam 336a and 334a, at angle Ψa.

FIG. 3A shows the beam traces of the two beams 328a and 330a, and the two beams 326a and 324a, in a negative single-axis crystal, such as TiO.sub.2 or YVO.sub.4. The polarizations in the two beams should be exchanged in FIG. 3A if a positive single-axis crystal, for example calcite, is used.

We can calculate a prism polarization beam angle, Ψ, as:

Ψ≈2 sin⁻¹[(nₑ−n₀)tan θ]

By flipping FIG. 3A horizontally, as shown in FIG. 3B, the Wollaston prism functions as a polarization combiner 360. In said combiner 360, we can design a wedge angle θb so as to obtain a polarization beam angle Ψb in the air that exactly matches the angle between a first polarized light beam 336b and a second polarized light beam 334b, which are collimated orthogonally-polarized beams.

As one of the advantages of this device, the prism thickness is not critical. Adjusting the prism slightly forward or backward in the assembly so that the beams meet at the right position can compensate a slight deviation in the prism thickness.

In order to allow the two polarization beams to meet and combine at a distance from the GRIN lens through the Wollaston prism (the key combining element), the collimating GRIN lens (i.e. the first GRIN lens 230 in FIG. 2) should be shorter than a quarter pitch. As a result, the prism polarization beam angle Ψb will be slightly smaller than that in quarter-pitch case; i.e. slightly smaller than 3.6° (=1.8°×2). A thicker prism requires a shorter GRIN lens. For the sake of the device size and better GRIN lens collimating quality, a thin prism is preferable.

In a traditional Wollaston prism, the two crystal wedges are cemented together along their oblique interface to form a composite block. The two wedges have their optic axis at a right angle to each other. However, the cement prevents the prism from operating under high power laser light. Therefore, in a second embodiment of this invention, we modify a Wollaston prism to ensure an epoxy-free optical path. We apply the cement around the edges only and leave an air gap in the middle area. The two oblique surfaces are AR-coated to minimize the optical beam insertion loss.

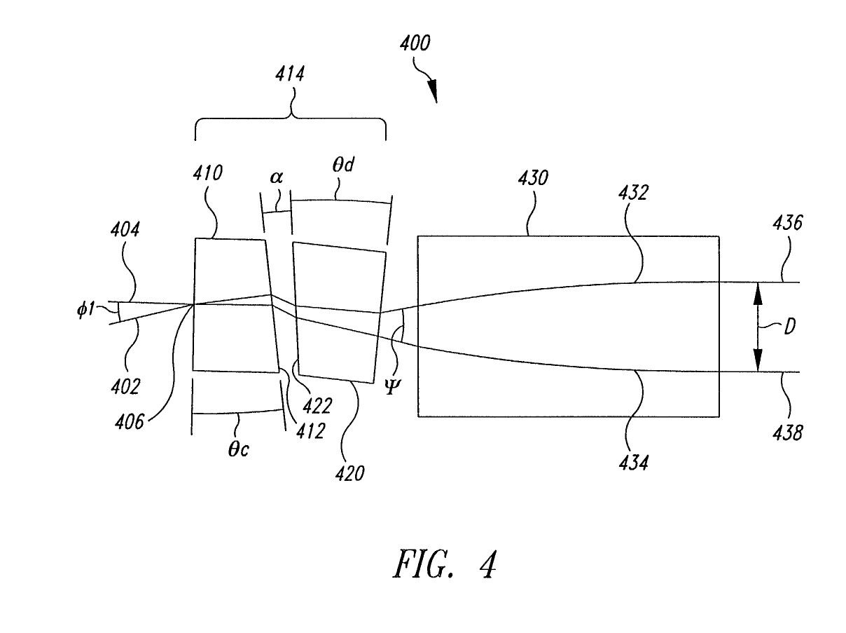

FIG. 4 shows a Wollaston prism model 400 for calculation that offers a general case. In FIG. 4, it is treated as a polarization splitter. The Wollaston prism model 400, shown here as a splitter from left to right, comprises a Wollaston prism 414, a shorter than quarter pitch GRIN lens 430, a first fiber tip 436, a second fiber tip 438, and a fiber spacing D. The Wollaston prism 414 comprises a first crystal wedge 410, a first crystal wedge oblique angle θc, a second crystal wedge 420, a second crystal wedge oblique angle θd. Also shown is a polarization beam angle Ψ, a first polarized light beam centerline 432, and a second polarized light beam centerline 434.

In this model, we allow some imperfections in the assembly, including an incidence angle φ1 of an entering collimated light beam 402 with respect a first crystal wedge perpendicular axis 404, as well as a misalignment angle α between a first crystal wedge oblique surface 412 and a second crystal wedge oblique surface 422.

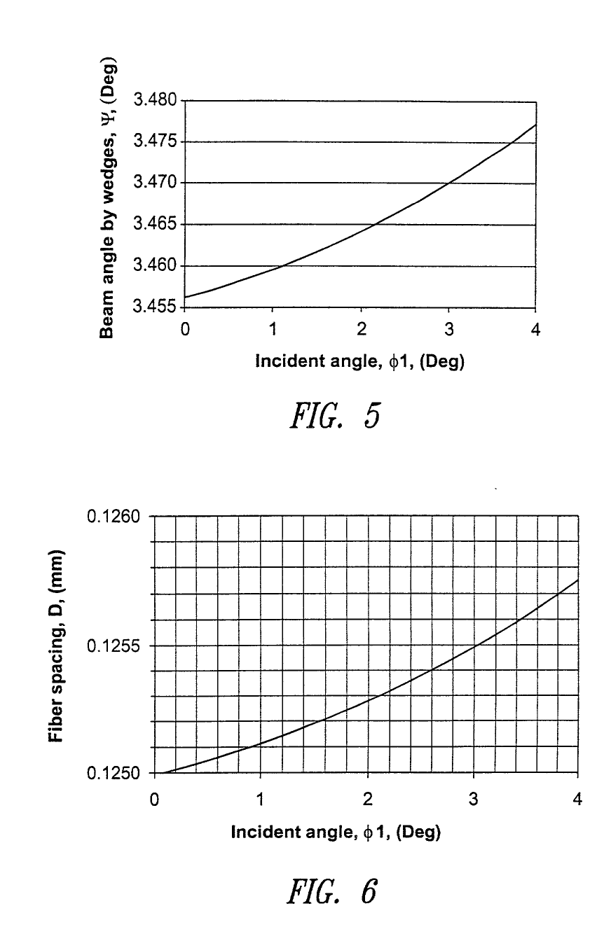

Using a given TiO.sub.2-made Wollaston prism with θ≈7° and a GRIN lens with a pitch<0.2, we calculated how these imperfect alignments will affect the prism polarization beam angle Ψ and consequently the fiber spacing D. In general, D needs to be equal to 0.125 mm to match the dual fiber spacing. Therefore, an insensitivity of D to part assembly imperfections is important to production. FIG. 5 shows the graph of Ψ vs. φ1, and FIG. 6 shows the graph of D vs. φ1. In both FIGS. 5 and 6 we have assumed α=0. It can be seen that the fiber spacing D is not sensitive to the incident angle φ1. Even a 3° tilt (a very bad case in real practice) will cause only 0.5 μm of D change.

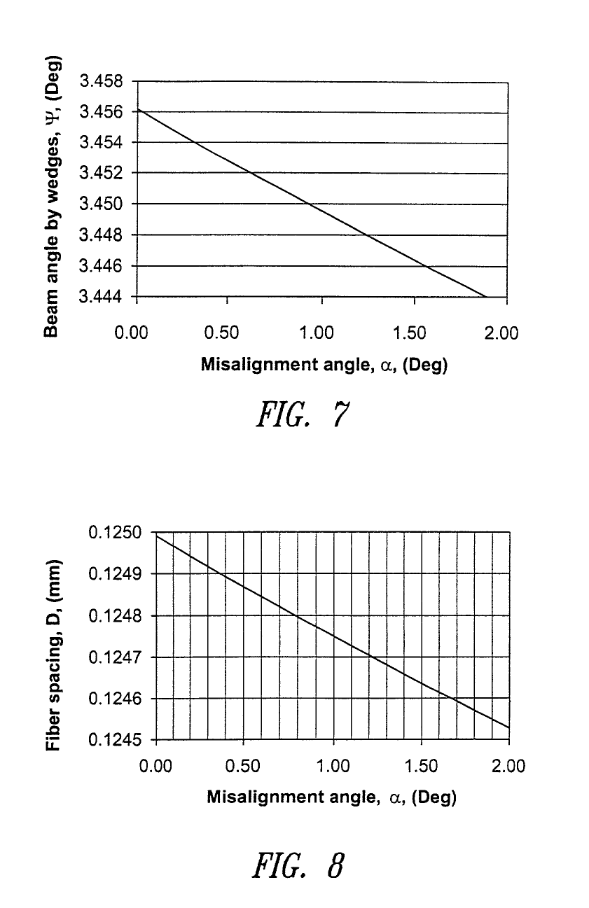

FIG. 7 shows the graph of Ψ vs. α, and FIG. 8 shows the graph of D vs. α. In both FIGS. 7 and 8 we have assumed φ1=0. Again, as we can see, neither beam angle Ψ nor the fiber spacing D is very sensitive to the un-parallelism of the two oblique surfaces. A 2° deviation from parallel (a bad case in real practice) will cause only 0.5 μm of change to D.

All the above results indicate that the parts assembly will not be very critical in this design. Regarding FIG. 4, with the above imperfections, the beams' meeting point will not be on a wedge interface as in the perfect case. They will meet at a combined exit point 406. Position compensation can be achieved by slightly adjusting the prism forward or backward. As shown in FIG. 5 and FIG. 7, Ψ is indeed slightly smaller than 3.6°, as expected before.

An advantage of the present invention, for example as shown in FIG. 4, is its small size. Because of the miniaturization of a thin Wollaston prism, or other similar single- or multiple-wedge design, substantial cost reduction can be obtained in materials, and applications will not be limited by excessive size.

Another advantage of the present invention is simplicity of assembly, with few optical elements and a one-dimensional design. This will also give a substantial cost reduction.

Still another advantage of the present invention is simplicity of alignment of crystals. Matching the beam angle of the first, less-than quarter pitch, collimating lens and the beam angle determined by the birefringent crystal wedge assembly allows fine-tuning of the elements before the apparatus is constructed.

Yet another advantage of the present invention is its less critical optical nature. By contrast, a critical aspect of the common walk-off combiner/splitter design, as shown in the prior art of FIG. 1, is a meeting point of two polarized light beams, an o-beam and an e-beam. For a Wollaston-like prism the meeting point aspect of the design is not critical.

Numerous other forms of the invention, fully within the spirit and intent of the present invention, could be devised. These, and other modifications to the preferred embodiment would be obvious to one of ordinary skill. Therefore, it is intended that the foregoing detailed description be regarded as illustrative, rather than limiting, and that it be understood that it is the following claims, including all equivalents, which are intended to define the protected scope of this invention. The invention is bidirectional, however, for the sake of clarity in claiming, the claims are written where two light beams are combined into a single light beam. The apparatus and method work equally well when a single light beam is split into two light beams.

### INDUSTRIAL APPLICABILITY

The apparatus and method are used to combine two linearly polarized beams of light into a single beam of light, or to split one beam of light into two linearly polarized beams, depending on the direction light is transmitted through the apparatus. The apparatus and method are capable of being used in the fiber optics industry to combine two beams of light with the same wavelength into a single beam. This allows two outputs of two optical pump lasers to be combined into a single light beam. The apparatus and method can be operated in the reverse direction to separate a single beam of light in a fiber optic cable into two linearly polarized beams with the same wavelength, each of the two beams being directed into a separate fiber optic cable. The apparatus results in an easily manufactured, compact, and slim device for fiber optics and other industrial uses.

I claim:

1. An optical beam combiner/splitter comprising:
a pair of closely-spaced optical waveguides, comprising a first waveguide and a second waveguide;
a third optical waveguide disposed a distance from the pair of closely-spaced optical waveguides and optically coupled therewith;
a first lens having a first optical axis, said lens being optically disposed between the pair of closely-spaced optical waveguides and the third optical waveguide, said first lens substantially collimating optical beams from the first waveguide and the second waveguide;
a polarizing beam splitter element optically disposed between the first lens and a second lens, said polarizing beam splitter element combining collimated optical beams from the first lens; and
said second lens having a second optical axis, said second lens being optically disposed between the polarizing beam splitter element and the third optical waveguide, said second lens focusing the combined light beams onto the third waveguide,
whereby, when functioning as a combiner, optical beams launched into the apparatus from the first and second waveguides are combined and received by the third waveguide, and when functioning as a splitter, an optical beam launched into the apparatus from the third waveguide is split with one component being received by the first waveguide and the other component being received by the second waveguide.

2. The apparatus of claim 1, wherein at least one of the optical waveguides is an optical fiber.

3. The apparatus of claim 1, wherein the claimed elements are positioned substantially along a single longitudinal axis.

4. The apparatus of claim 1, wherein at least one lens is a collimating gradient index lens.

5. The apparatus of claim 1, wherein the first lens has its focus point outside of said lens at a distance whereby light beams from the pair of closely spaced waveguides exit said first lens while converging and without crossing.

6. The apparatus of claim 1 ,wherein the polarizing beam splitter element is a pair of birefringent crystal wedges.

7. The apparatus of claim 6, wherein the two wedges of the pair of birefringent crystal are bonded along the periphery of their adjoining faces so as to maintain a bond-free optical path.

8. The apparatus of claim 6, wherein the polarizing beam splitter element is selected from the group consisting of a Wollaston prism and a Rochon prism.

9. The apparatus of claim 1, wherein a first optical pump laser is optically connected to the first wave guide and a second optical pump laser is connected to the second wave guide, whereby the apparatus functions as a pump combiner.

10. An optical beam combiner/splitter comprising:
a pair of closely-spaced optical fibers, comprising a first optical fiber having a first tip and a second optical fiber having a second tip;
a third optical fiber having a third tip, said third optical fiber being disposed a distance from the pair of closely-spaced optical fibers and optically coupled therewith;
a first collimating gradient index lens having a length shorter than one-quarter pitch, having a first optical axis therethrough, and being optically disposed between the pair of closely-spaced optical fibers and the third optical fiber, said first lens substantially collimating optical beams from the first pair of closely-spaced optical fibers whereby the light beams exit said first lens while converging and without crossing;
a polarizing beam splitter element being optically disposed between the first lens and a second collimating gradient lens, said polarizing beam splitter element being matched with the first lens for combining the collimated optical beams from the first lens; and
said second collimating gradient index lens having a second optical axis therethrough, and being optically disposed between the polarizing beam splitter element and the third optical fiber, said second lens focusing the combined light beams from the polarizing beam splitter element onto the third tip,
whereby, when functioning as a combiner, optical beams launched into the apparatus from the first and second optical fibers are combined and received by the third optical fiber, and when functioning as a splitter, an optical beam launched into the apparatus from the third optical fiber is split with one component being received by the first optical fiber and the other component being received by the second optical fiber.

11. The apparatus of claim 10, wherein the first tip and second tip are transversely offset from the lens axis of the first collimating gradient index lens, such that a beam of light propagating from one of said tips through the first collimating gradient index lens will be tilted with respect to the lens axis of the first collimating gradient index lens.

12. The apparatus of claim 10, wherein the claimed elements are positioned substantially along a single longitudinal axis.

13. The apparatus of claim 10, wherein the polarizing beam splitter element is a pair of birefringent crystal wedges.

14. The apparatus of claim 13, wherein the two wedges of birefringent crystal are bonded along the periphery of their adjoining faces so as to maintain a bond-free optical path.

15. The apparatus of claim 13, wherein the polarizing beam splitter element is selected from the group consisting of a Wollaston prism and a Rochon prism.

16. The apparatus of claim 10, wherein a first optical pump laser is optically connected to the first optical fiber and a second optical pump laser is connected to the second optical fiber, whereby the apparatus functions as a pump combiner

17. A method of splitting and combining beams of light, said method comprising:
providing a pair of closely-spaced optical wave guides, comprising a first wave guide and a second wave guide;
providing a third optical wave guide disposed a distance from the pair of closely-spaced optical waveguides and optically coupled therewith;
providing a first lens having a length shorter than one-quarter pitch, having a first optical axis therethrough, said first lens substantially collimating optical beams from the first pair of closely-spaced optical fibers whereby the light beams exit said first lens while converging and without crossing;
optically coupling the first lens to the pair of closely-spaced optical waveguides;
providing a polarizing beam splitter element combining the substantially collimated optical beams from the first lens;
optically coupling the polarizing beam splitter element to the first lens such that the polarizing beam splitter element is on the opposite side of the first lens from the pair of closely-spaced optical wave guides;
providing a second lens having an optical axis therethrough, said second lens focusing the combined light beams from the polarizing beam splitter element into the third optical wave guide;
optically coupling the second lens to the polarizing beam splitter element such that the second lens is on the opposite side of the beam splitter from the first lens; and
optically coupling the third optical wave guide to the second lens such that the third optical wave guide is coupled on the opposite side of the second lens from the coupling with the polarizing beam splitter element,
whereby, when functioning as a combiner, optical beams launched from the first and second waveguides are combined and received by the third waveguide, and when functioning as a splitter, an optical beam launched from the third waveguide is split with one component being received by the first waveguide and the other component being received by the second waveguide.

18. The method of claim 17, wherein the first waveguide and second waveguide terminate at points adjacent to the first lens and are transversely offset from the lens axis, such that a beam of light propagating from one of said waveguides through the first lens will be tilted with respect to the lens axis.

19. The method of claim 17, wherein the polarizing beam splitter element is a pair of birefringent crystal wedges.

20. The method of claim 19, wherein the polarizing beam splitter element is selected from the group consisting of a Wollaston prism and a Rochon prism.
